(19) United States
(12) Patent Application Publication
(10) Pub. No.: US 2025/0193031 A1
(43) Pub. Date: Jun. 12, 2025

(54) METHOD FOR PRIVATE SET INTERSECTION IN SMART CITY SYSTEM, DEVICE, AND STORAGE MEDIUM

(71) Applicants: Hangzhou City University, Hangzhou (CN); Zhejiang University, Hangzhou (CN); Zhejiang Construction Investment Group Co., Ltd., Hangzhou (CN); Hangzhou Hyperchain Technology Co., Ltd., Hangzhou (CN); Qi An Xin Technology Group Inc., Beijing (CN)

(72) Inventors: Song HAN, Hangzhou (CN); Zhibo WANG, Hangzhou (CN); Rui JIN, Hangzhou (CN); Xiaofeng CHEN, Hangzhou (CN); Wei XIA, Beijing (CN)

(73) Assignees: Hangzhou City University, Hangzhou (CN); Zhejiang University, Hangzhou (CN); Zhejiang Construction Investment Group Co., Ltd, Hangzhou (CN); Hangzhou Hyperchain Technology Co., Ltd., Hangzhou (CN); Qi An Xin Technology Group Inc., Beijing (CN)

(21) Appl. No.: 18/977,462

(22) Filed: Dec. 11, 2024

(30) Foreign Application Priority Data
Dec. 12, 2023 (CN) 2023117022331

(51) Int. Cl. H04L 9/00; H04L 9/08; H04L 9/32

(52) U.S. Cl. CPC H04L 9/50; H04L 9/0825; H04L 9/085; H04L 9/0869; H04L 9/3236

(57) ABSTRACT

The present invention discloses a method for private set intersection in a smart city system, a device, and a storage medium. According to the present invention, a threshold secret sharing technology is adopted to share a private set among three parties, so that an intersection cardinality is hidden and security of private set intersection is improved. Before two parties perform the private set intersection, a blockchain is used to verify identities of the two parties, which protects security of data of the two parties to a certain extent. In addition, according to the present invention, the private set is divided into a plurality of subsets with labels, which implements an interaction manner with finer granularity. Therefore, compared with a private set intersection solution in a previous smart city system, the present invention is greatly improved in practicability, security, and other aspects.

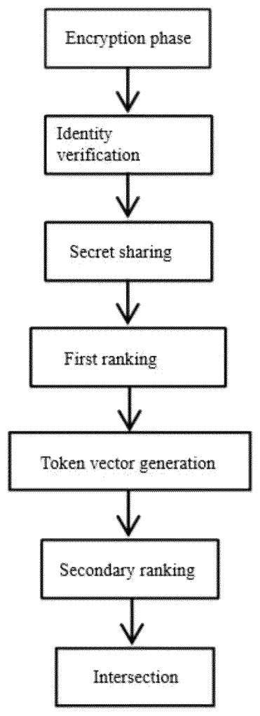

### CROSS-REFERENCE TO RELATED APPLICATIONS

The application claims priority to Chinese patent application No. 2023117022331, filed on Dec. 12, 2023, the entire contents of which are incorporated herein by reference.

### TECHNICAL FIELD

The present invention belongs to the field of private set intersection, and specifically, relates to a method for private set intersection in a smart city system, a device, and a storage medium.

### BACKGROUND

In a smart city management system, scenarios of performing intersection between two parties are becoming more and more common. A private set intersection solution in the smart city management system may ensure the privacy of set elements in addition to an intersection set of the two parties. However, in the private set intersection solution, sizes of two sets are required to be uniform, but in real life, the sizes of the sets are skewed. In addition, since a set in current private set intersection is only a single set, problems in storage, efficiency, and other aspects easily occur during set intersection.

### SUMMARY

A purpose of the present invention is to provide a method for private set intersection in a smart city system, a device, and a storage medium.

The present invention adopts the following technical solutions:

A method for private set intersection in a smart city system, where the method includes the following steps:
(1) using, by all participants, a hash function generated by a third party Pc and respective public keys to perform encryption, to generate respective ciphertexts, and sending the respective ciphertexts to a blockchain, where all the participants include a participant Pa and a participant Pb;
(2) using the blockchain to verify identities of all the participants before private intersection is performed, to determine whether the private intersection can be performed;
(3) sharing, by the participant Pa and the participant Pb, subsets of respective private sets among three parties after it is determined that the private intersection can be performed;
(4) obtaining subvectors by the three parties after sharing, and then ranking subvectors of the participant Pₐ and the participant P_{b};
(5) jointly calculating, by the three parties, a secret sharing vector of one token vector, and then performing secondary ranking on ranked subvectors of the participant Pₐ and the participant P_{b} according to the secret sharing vector, to obtain a ranked subsecret combination vector; and
(6) recovering, by the participant Pₐ and the participant P_{b}, respective subsecret combination vectors by invoking a Reveal algorithm, to obtain an intersection set R.

Further, the step (1) specifically is that:
the third party P_{c} uses a security parameter λ_{1, 2} to generate a hash function H₁ and a hash function H₂;
the participant Pₐ selects a random value a as a private key skₐ of the participant Pₐ, and uses the private key to calculate a public key pkₐ; and similarly, the participant P_{b} selects a random value b as a private key sk_{b} of the participant P_{b}, and uses the private key to calculate a public key pk_{b};
the participant Pₐ generates a ciphertext U₁ through the hash function H₁ and the public key pkₐ, and the participant P_{b} generates a ciphertext U₂ through the hash function H₂ and the public key pk_{b}; and
then the ciphertext U₁ and the ciphertext U₂ are sent to the blockchain.

Further, the step (2) specifically is that:
first, the participant Pₐ exchanges an EOA address with the participant P_{b}; then, the participant P_{b} uses a public key of the participant Pₐ to encrypt a public key and a ciphertext of the participant P_{b}, and packs a ciphertext CI_{b} into a transaction to be sent to the blockchain; when private set intersection needs to be performed, the Pₐ inquires a recent transaction, extracts a ciphertext in the recent transaction, and then decrypts the ciphertext by using a private key of the Pₐ; a public key PK_{b} of the participant P_{b} is decrypted, a hash operation is performed on the public key, last 20 characters of an operation result are intercepted as R₁, the R₁ is matched with an address Addr that sends the transaction, and if the R₁ is the same as the address, it indicates that the participant P_{b} authorizes the other party and desires to perform a private set intersection operation; and the P_{b} inquires a recent transaction in the blockchain, and uses the EOA address to check whether the EOA address is an address of the Pₐ, and if the EOA address is the address of the Pₐ, it indicates that the Pₐ desires to perform a private set intersection operation.

Further, the three parties in the step (3) include the participant Pₐ, the participant P_{b}, and the third party P_{c}.

Further, the step (4) specifically is that:
the participant Pₐ obtains subvectors [symbol] and [symbol] the participant P_{b} obtains subvectors [symbol] and [symbol] and the P_{c} obtains subsecrets [symbol] and [symbol] then a set of subsecrets held by the participant Pₐ is combined and is represented as a vector [symbol] and a set of subsecrets held by the participant P_{b} is combined and is represented as a vector [symbol] and subsecret combination vectors [symbol] and [symbol] held by the participant Pₐ and the participant P_{b} are ranked according to element sizes, to generate vectors [symbol] and

[symbol]

Further, the step (5) specifically is that:
three participants jointly calculate a secret sharing vector [symbol] of one token vector [symbol] and rank vectors [symbol] and [symbol] according to a value of [\vec{fₖ}], to obtain a subsecret combination vector (a′₁, a′₂) ranked according to [\vec{fₖ}].

Further, the step (6) specifically is that:
the participant Pₐ sends a subsecret vector ( [symbol] , a′₁) thereof to the participant P_{b}, and similarly, the participant P_{b} sends a subsecret combination vector ( [symbol] , a′₂) thereof to the Pₐ; the participant Pₐ and the participant P_{b} respectively invoke the Reveal algorithm according to held subsecret vectors [symbol] and [symbol] to recover a token vector [\vec{fₖ}], and finally, a number of elements with [\vec{fₖ}]=1 is a number N of intersection set elements; the participant Pₐ extracts last N elements in a′₁ and sends the elements to the participant P_{b}; similarly, the participant P_{b} extracts last N elements in a′₂ and sends the elements to the participant Pₐ; and the participant Pₐ and the participant P_{b} recover, according to the Reveal algorithm, last N subsecret vectors that are received, to obtain an intersection set R.

The present invention further provides an electronic device, including a memory and a processor, where the memory is configured to store a computer program, and the processor runs the computer program, to enable the electronic device to execute the above method for private set intersection in a smart city system.

The present invention further provides a computer-readable storage medium, having a computer program stored thereon, where the computer program, when executed by a processor, implements the above method for private set intersection in a smart city system.

Beneficial effects of the present invention are as follows:

The present invention has relatively high practicability and expandability. The present invention is suitable for a scenario in which private set intersection needs to be performed in a smart city system. According to the present invention, a secret sharing technology is used to reduce requirements on a size of a private set and protect an intersection cardinality of the private set; and intersection of fine granularity of the set is implemented through multi-subset division. According to the present invention, an identity verification technology is used to determine identities of two parties, which can ensure correctness of the identities of the two parties, improve a protection degree of the private set, and further reduce computational overheads of intersection greatly.

### BRIEF DESCRIPTION OF THE DRAWINGS

The accompanying drawings show various embodiments by way of examples and not limitations, and are used in conjunction with the specification and the claims to describe the embodiments of the present invention. Appropriately, the same reference numerals used in all accompanying drawings denote the same or similar parts. Such embodiments are illustrative and are not intended as exhaustive or exclusive embodiments of the apparatus or method.

The FIGURE is a schematic flowchart of a method of the present invention.

### DETAILED DESCRIPTION OF THE EMBODIMENTS

It should be noted that the embodiments and features in the embodiments of the present application may be combined with each other without conflict. The present application will be described in detail below with reference to the accompanying drawings and the embodiments.
1) In an initialization phase, as a credible third party P_{c}, a blockchain uses a security parameter λ_{1, 2} to generate hash functions H₁ and H₂.
2) In a key generation phase, there are two participants, which respectively are Pₐ and P_{b}. The participant Pₐ selects a random value a as a private key skₐ of the participant Pₐ, and uses the private key to calculate a public key pkₐ. Similarly, the participant P_{b} selects a random value b as a private key sk_{b} of the participant P_{b}, and uses the private key to calculate a public key pk_{b}.
3) During set encryption, it is assumed that the participant Pₐ has n subsets A=

{A₁, A₂, . . . , Aₙ}. As with the participant Pₐ, it is assumed that the participant P_{b} has m subsets B={B₁, B₂, . . . , Bₘ}.
4) The participant Pₐ performs hash on element subsets, to generate a ciphertext U₁, and sends the ciphertext U₁ to the blockchain; and the participant P_{b} uses the public key of the participant P_{b} to execute a same operation, to generate a ciphertext U₂, and sends the ciphertext U₂ to the blockchain.
5) Two parties of the participants exchange an EOA address before private intersection is performed.
6) Then, the participant P_{b} uses the public key of the participant Pₐ to encrypt the public key and the ciphertext of the participant P_{b}, to generate CI_{b}=PKₐ (PK_{b}∥U₂), and packs the ciphertext CI_{b} into a transaction to be sent to the blockchain.
7) When private set intersection needs to be performed, the Pₐ inquires a recent transaction, extracts a ciphertext in the recent transaction, and then decrypts the ciphertext by using the private key of the Pₐ. The public key PK_{b} of the participant P_{b} is decrypted, a hash operation is performed on the public key, and last 20 characters of an operation result is intercepted as R₁. The R₁ is matched with an address Addr that sends the transaction, and if the R₁ is the same as the address, it indicates that the participant P_{b} authorizes the other party and desires to perform a private set intersection operation.
8) The P_{b} inquires a recent transaction in the blockchain, and uses the EOA address to check whether the EOA address is an address of the Pₐ, and if the EOA address is the address of the Pₐ, it indicates that the Pₐ desires to perform a set intersection operation.
9) The participant Pₐ and the participant P_{b} share subsets of respective private

sets among three parties after it is determined that the intersection operation may be performed.
10) The participant Pₐ obtains subvectors [symbol] and [symbol] ; and similarly, the participant P_{b} obtains subvectors [symbol] and [symbol] , and the P_{c} obtains subsecrets [symbol] and [symbol] .
11) A set of subsecrets held by the participant Pₐ is combined and is represented as a vector [symbol] and a set of subsecrets held by the participant P_{b} is represented as a vector [symbol] .
12) The participant Pₐ and the participant P_{b} rank held subsecret combination vectors [symbol] and [symbol] according to element sizes, to generate vectors [symbol] and [symbol]
13) Three participants jointly calculate a secret sharing vector [symbol] =( [symbol] , [symbol] . . . , [symbol] ) of one token vector [symbol] where a generation manner of a subvector of each token vector is as follows:
(1) initializing [symbol] =[0]; and
(2) for 2≤k≤n, if a value of a latter term is the same as that of a previous term, [symbol] =1; and if a value of a latter term is different from that of a previous term, [symbol] =0.
14) The participants rank a₁ and a₂ according to a value of [symbol] , to obtain subsecret combination vectors a′₁ and a′₂ ranked according to [symbol] .
15) The participant Pₐ sends a subsecret vector ( [symbol] , a′₁) thereof to the participant P_{b}, and similarly, the P_{b} sends a subsecret combination vector ( [symbol] , a′₂) thereof to the Pₐ.
16) The participant Pₐ and the participant P_{b} respectively invoke a Reveal algorithm according to held subsecret vectors [symbol] and [symbol] , to recover a token vector [symbol] , and finally, a number of elements with [symbol] =1 is a number N of intersection set elements.
17) The participant Pₐ extracts last N elements in a′₁ and sends the elements to the P_{b}. Similarly, the participant P_{b} extracts last N elements in a′₂ and sends the elements to the Pₐ.
18) The participant Pₐ and the participant P_{b} recover, by invoking the Reveal algorithm, last N subsecret vectors that are received, to obtain an intersection set R.

In step 1): the security parameter needs to be used to generate two hash functions, and the two hash functions respectively are used to encrypt a set A and a set B.

In step 12): the elements are ranked according to the element sizes. Since same elements may not appear in each set, after elements of two sets are combined, the elements are ranked according to the element sizes, so that same elements in the two sets may be at adjacent positions.

In step 14): after the elements are ranked again according to a size of a token vector, elements with a token vector being 1 may be ranked at the rear of the set, and these elements are intersection set elements. A reason is that when the token vector is generated, a latter element needs to be compared with a previous element, and the latter element is the same as the previous element, the token vector is labeled as 1, which indicates that this element is an intersection set element of two sets. After ranking is performed again by using the token vector, this intersection set element is ranked backward with the size of the token vector, which means that elements with the token vector being 1 may be extracted, to obtain the intersection set elements.

In step 16): the token vector is recovered through the Reveal algorithm, and a

Reveal recovery algorithm is an algorithm in a secret sharing technology, which means that a secret message is recovered and revealed, and when any two sub-token vectors are known, a linear secret sharing solution may recover and reveal this token vector.

In step 18): the intersection element is recovered through the Reveal algorithm, and as with the above, a Reveal recovery algorithm is an algorithm in a secret sharing technology, which means that a secret message is recovered and revealed. After two participants find an intersection set subelement in respective subsecrets through the token vector, the two participants send the intersection set subelements to each other, and the Reveal recovery algorithm in the linear secret sharing solution may recover and reveal this intersection set element.

### Embodiment 1

First, in an initialization phase, as a credible third party P_{c}, a blockchain uses a security parameter 21, 2 to generate hash functions H₁ and H₂; and in a key generation phase, there are two participants, which respectively are Pₐ and P_{b}. The participant Pₐ selects a random value a as a private key skₐ of the participant Pₐ, and uses the private key to calculate a public key pkₐ. Similarly, the participant P_{b} selects a random value b as a private key sk_{b} of the participant P_{b}, and uses the private key to calculate a public key pk_{b}. Then, a set is encrypted, and during set encryption, it is assumed that the participant Pₐ has n subsets A={A₁, A₂, . . . , Aₙ}. As with the participant Pₐ, it is assumed that the participant P_{b} has m subsets B={B₁, B₂, . . . , Bₘ}. During encryption, the participant Pₐ performs hash on element subsets, to generate a ciphertext U₁, and sends the ciphertext U₁ to the blockchain; and the participant P_{b} uses the public key of the participant P_{b} to execute a same operation, to generate a ciphertext U₂, and sends the ciphertext U₂ to the blockchain.

Then, the blockchain is used to verify identities of two parties before private intersection is performed. First, the two parties of the participants exchange an EOA address; and then, the participant P_{b} uses the public key of the participant Pₐ to encrypt the public key and the ciphertext of the participant P_{b}, to generate CI_{b}=PKₐ (PK_{b}∥U₂), and packs the ciphertext CI_{b} into a transaction to be sent to the blockchain. When private set intersection needs to be performed, the Pₐ inquires a recent transaction, extracts a ciphertext in the recent transaction, and then decrypts the ciphertext by using the private key of the Pₐ. The public key PK_{b} of the participant P_{b} is decrypted, a hash operation is performed on the public key, and last 20 characters of an operation result is intercepted as R₁. The R₁ is matched with an address Addr that sends the transaction, and if the R₁ is the same as the address, it indicates that the participant P_{b} authorizes the other party and desires to perform a private set intersection operation. As with an operation of the Pₐ, the P_{b} inquires a recent transaction in the blockchain, and uses the EOA address to check whether the EOA address is an address of the Pₐ, and if the EOA address is the address of the Pₐ, it indicates that the Pₐ desires to perform a set intersection operation.

The participant Pₐ and the participant P_{b} share subsets of respective private sets among three parties after it is determined that the intersection operation may be performed. The participant Pₐ obtains subvectors [symbol] and [symbol] ; and similarly, the participant P_{b} obtains subvectors [symbol] and [symbol] and the P_{c} obtains subsecrets [symbol] and [symbol] . Then, a set of subsecrets held by the participant Pₐ is combined and is represented as a vector [symbol] and a set of subsecrets held by the participant P_{b} is represented as a vector [symbol] . The participant Pₐ and the participant P_{b} rank held subsecret combination vectors [symbol] and [symbol] according to element sizes, to generate vectors [symbol] and [symbol] .

Then, three participants jointly calculate a secret sharing vector [symbol] =( [symbol] , [symbol] , . . . , [symbol] ) of one token vector [symbol] , and the participants rank (a₁, a₂) according to a value of [symbol] to obtain a subsecret combination vector (a′₁, a′₂) ranked according to [symbol] .

The participant Pₐ sends a subsecret vector ( [symbol] , a′₁) thereof to the participant P_{b}, and similarly, the participant P_{b} sends a subsecret combination vector ( [symbol] , a′₂) thereof to the Pₐ; and the participant Pₐ and the participant P_{b} respectively invoke a Reveal algorithm according to held subsecret vectors [symbol] and [symbol] to recover a token vector [symbol] and finally, a number of elements with [symbol] =1 is a number N of intersection set elements. The participant Pₐ extracts last N elements in a′₁ and sends the elements to the P_{b}. Similarly, the participant P_{b} extracts last N elements in a′₂ and sends the elements to the Pₐ; and the participant Pₐ and the participant P_{b} recover, by invoking the Reveal algorithm, last N subsecret vectors that are received, to obtain an intersection set R.

Therefore, the secret sharing technology used in the present invention is that two participants may obtain an intersection set of sets on condition that sizes of private sets are different, and during execution, a size of an intersection set cardinality is not revealed. In addition, the set is divided into multiple subsets, which not only can implement a fine granularity operation, but also is helpful for extensive application in real life. In conclusion, the private set intersection solution may be applied to the smart city system more widely and securely through technologies such as blockchain verification, multi-subset division, secret sharing, and the like.

The foregoing descriptions are merely preferred specific implementations of the present invention, but are not intended to limit the protection scope of the present invention. Any equivalent replacement or variation made by a person skilled in the art according to the technical solutions of the present invention and the inventive concept thereof within the technical scope disclosed in the present invention shall fall within the protection scope of the present invention.

What is claimed is:

1. A method for private set intersection in a smart city system, wherein the method comprises the following steps:
(1) using, by all participants, a hash function generated by a third party P_{c} and respective public keys to perform encryption, to generate respective ciphertexts, and sending the respective ciphertexts to a blockchain, wherein all the participants comprise a participant Pₐ and a participant P_{b};
(2) using the blockchain to verify identities of all the participants before private intersection is performed, to determine whether the private intersection can be performed;
(3) sharing, by the participant Pₐ and the participant P_{b}, subsets of respective private sets among three parties after it is determined that the private intersection can be performed;
(4) obtaining subvectors by the three parties after sharing, and then ranking subvectors of the participant Pₐ and the participant P_{b};
(5) jointly calculating, by the three parties, a secret sharing vector of one token vector, and then performing secondary ranking on ranked subvectors of the participant Pₐ and the participant P_{b} according to the secret sharing vector, to obtain a ranked subsecret combination vector; and
(6) recovering, by the participant Pₐ and the participant P_{b}, respective subsecret combination vectors by invoking a Reveal algorithm, to obtain an intersection set R.

2. The method for private set intersection in a smart city system according to claim 1, wherein the step (1) specifically is that:
the third party P_{c} uses a security parameter 21, 2 to generate a hash function H₁ and a hash function H₂;
the participant Pₐ selects a random value a as a private key skₐ of the participant Pₐ, and uses the private key to calculate a public key pkₐ; and similarly, the participant P_{b} selects a random value b as a private key sk_{b} of the participant P_{b}, and uses the private key to calculate a public key pk_{b};
the participant Pₐ generates a ciphertext U₁ through the hash function H₁ and the public key pkₐ, and the participant P_{b} generates a ciphertext U₂ through the hash function H₂ and the public key pk_{b}; and
then the ciphertext U₁ and the ciphertext U₂ are sent to the blockchain.

3. The method for private set intersection in a smart city system according to claim 1, wherein the step (2) specifically is that:
first, the participant Pₐ exchanges an EOA address with the participant P_{b}; then, the participant P_{b} uses a public key of the participant Pₐ to encrypt a public key and a ciphertext of the participant P_{b}, and packs a ciphertext CI into a transaction to be sent to the blockchain; when private set intersection needs to be performed, the Pₐ inquires a recent transaction, extracts a ciphertext in the recent transaction, and then decrypts the ciphertext by using a private key of the Pₐ; a public key PK_{b} of the participant P_{b} is decrypted, a hash operation is performed on the public key, last 20 characters of an operation result are intercepted as R₁, the R₁ is matched with an address Addr that sends the transaction, and if the R₁ is the same as the address, it indicates that the participant P_{b} authorizes the other party and desires to perform a private set intersection operation; and the P_{b} inquires a recent transaction in the blockchain, and uses the EOA address to check whether the EOA address is an address of the Pₐ, and if the EOA address is the address of the Pₐ, it indicates that the Pₐ desires to perform a private set intersection operation.

4. The method for private set intersection in a smart city system according to claim 1, wherein the three parties in the step (3) comprise the participant Pₐ, the participant P_{b}, and the third party P_{c}.

5. The method for private set intersection in a smart city system according to claim 1, wherein the step (4) specifically is that:
the participant Pₐ obtains subvectors [symbol] and [symbol] the participant P_{b} obtains subvectors [symbol] and [symbol] and the P_{c} obtains subsecrets [symbol] and [symbol] then a set of subsecrets held by the participant Pₐ is combined and is represented as a vector [symbol] and a set of subsecrets held by the participant P_{b} is combined and is represented as a vector [symbol] and subsecret combination vectors [symbol] and [symbol] held by the participant Pₐ and the participant P_{b} are ranked according to element sizes, to generate vectors [symbol] and [symbol] .

6. The method for private set intersection in a smart city system according to claim 1, wherein the step (5) specifically is that:
three participants jointly calculate a secret sharing vector [symbol] of one token vector [symbol] and rank vectors [symbol] and [symbol] according to a value of [symbol] ], to obtain a subsecret combination vector (a′₁, a′₂) ranked according to [symbol] ].

7. The method for private set intersection in a smart city system according to claim 1, wherein the step (6) specifically is that:
the participant Pₐ sends a subsecret vector ( [symbol] , a′₁) there thereof to the participant P_{b}, and similarly, the participant P_{b} sends a subsecret combination vector ( [symbol] , a′₂) thereof to the Pₐ; the participant Pₐ and the participant P_{b} respectively invoke the Reveal algorithm according to held subsecret vectors [symbol] and [symbol] to recover a token vector [symbol] ], and finally, a number of elements with [symbol] =1 is a number N of intersection set elements; the participant Pₐ extracts last N elements in a′₁ and sends the elements to the participant P_{b}; similarly, the participant P_{b} extracts/last N elements in a′₂ and sends the elements to the participant Pₐ; and the participant Pₐ and the participant P_{b} recover, according to the Reveal algorithm, last N subsecret vectors that are received, to obtain an intersection set R.

8. Aₙ electronic device, comprising a memory and a processor, wherein the memory is configured to store a computer program, and the processor runs the computer program, to enable the electronic device to execute the method for private set intersection in a smart city system according to claim 1.

9. A computer-readable storage medium, having a computer program stored thereon, wherein the computer program, when executed by a processor, implements the method for private set intersection in a smart city system according to claim 1.
